(19) United States
(12) Patent Application Publication
(10) Pub. No.: US 2017/0177619 A1
(43) Pub. Date: Jun. 22, 2017

(54) SYSTEM AND METHOD FOR SEARCHING FOR PROPERTY AND DISPLAYING SEARCH RESULTS

(71) Applicant: Probidder, LLC, Palatine, IL (US)

(72) Inventors: Peter Georgiev, Palatine, IL (US); Bardan Azari, Park Ridge, IL (US); Boris Teoharov, Sofia (BG)

(21) Appl. No.: 15/295,401

(22) Filed: Oct. 17, 2016

Related U.S. Application Data
(60) Provisional application No. 62/270,548, filed on Dec. 21, 2015.

(51) Int. Cl. G06F 17/30; G06Q 50/16

(52) U.S. Cl. CPC G06F 17/30241; G06F 17/30867; G06Q 50/16

(57) ABSTRACT

A system and method of searching for real estate. A server is communicatively connected to a database comprised of real estate records. One or more client devices communicatively connected to the server receive a defined non-contiguous geographic search area and attribute criteria values for attributes of the sought real estate and the client devices transmit the defined non-contiguous geographic search area and attribute criteria values to the server. The server calculates minimum bounding rectangles corresponding to the non-contiguous geographic search area, queries the database of real estate using the minimum bounding rectangles and attribute criteria values to generate a first set of returned records, compares the first set of returned records against the defined non-contiguous search area to generate a second set of returned records that is a subset of the first set of returned records, and transmits the second set of returned records to the client device.

### CROSS-REFERENCE TO RELATED APPLICATION

This application claims priority from U.S. Provisional Patent Application No. 62/270,548, filed on Dec. 21, 2015, which is incorporated herein by reference in its entirety.

### BACKGROUND OF THE INVENTION

The description that follows relates to an improved system and method for searching for real estate based on user-defined attribute criteria and customized user-defined geographic areas and for displaying such search results via a network based computer system.

Real estate buyers and investors use on-line search tools via personal computers connected to a network to identify potential properties for purchase either directly or through auctions. On-line search tools allow such buyers to input search criteria which the system applies against a database representing the current market of available real estate properties to generate a list of results that meet the search criteria. Certain pre-existing on-line search tools enable a user to limit a real estate search to a certain geographic area defined by a boundary drawn on a map, as well as other search criteria such as type of building, price, square footage, number of bedrooms, etc. Certain pre-existing on-line search tools also permit users to save the search criteria and the user-defined geographic area as a saved search. These saved searches can periodically be applied to the current market of available real estate to generate an up to date list of real estate meeting the criteria.

However, the pre-existing search systems are limited in that they do not provide a way for users to combine a user-defined geographic area with multiple different sets of search criteria. Nor, do such pre-existing search systems allow a user to define and modify non-contiguous user-defined geographic areas when combining such areas with other attribute criteria. Nor, do such pre-existing search systems enable users to combine multiple user defined geographic search areas with one another.

### SUMMARY OF THE INVENTION

The search system according to the present invention enables a user to define non-contiguous geographic areas on a single map, save those user-defined areas, and later recall and adjust such user-defined areas. The search system according to the present invention also enables a user to combine the saved user-defined areas with multiple sets of user-selected attribute criteria and save such combinations of user-defined areas and attribute criteria. The search system according to the present invention also enables a user to combine a first user-defined area with one or more additional saved user-defined areas. This functionality provides a means for a user to “re-use” the defined geographic areas with multiple different sets of search criteria by applying the saved geographic search areas as filters to a set of attribute criteria. It also allows the user to modify the user-defined areas when combining them with attribute criteria. In another aspect, the search system provides a means for creating an exclusion geographic area in which otherwise matching properties are excluded.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is schematic drawing of a system according to the present invention;

FIG. 2 is a flow chart showing a method for performing a search for a property based on user-defined geographic area and user-defined attribute criteria according to the present invention;

FIG. 3 is an example of a system display enabling user selection of attribute criteria and values for attribute criteria according to the present invention;

FIG. 4 is an example of a system display enabling user definition of a non-contiguous geographic area comprised of polygons and display of a results set according to the present invention;

FIG. 5 is an example of a system display enabling modification of a user defined a non-contiguous geographic area according to the present invention; and

FIG. 6 is an example of a system display enabling user definition of a circular geographic area according to the present invention.

Illustrative and exemplary embodiments of the invention are described in further detail below with reference to and in conjunction with the figures.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the disclosure is intended to cover all such embodiments that may fall within the scope of the appended claims, either literally or under the doctrine of equivalents.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

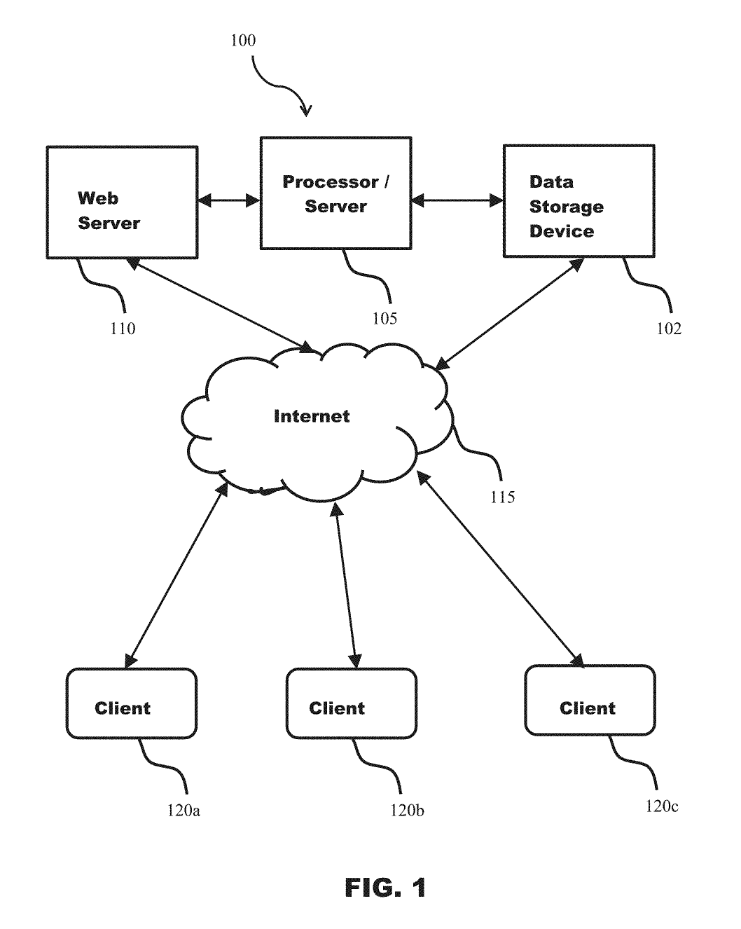

An exemplary system 100 according to the present invention is shown in FIG. 1. The system comprises a data storage device 102, also referred to herein as a memory, containing thereon a database of real estate property information, which is described in more detail below. The data storage device 102 is communicatively connected to a processor 105 and a web server 110, either directly or via an internet connection. Web server 110 is communicatively connected to exemplary client computers 120a, 120b and 120c via the internet 115 to transmit information to and receive information from the web server 110. Client computers 120a, 120b and 120c may be any one of a number of personal computers, handheld devices or tablet devices having a display screen, user input device, client computer memory and internet connectivity. An internet browser application is stored on and operated via the client computers 120a, 120b and 120c.

The database of real estate properties is preferably a relational database such as a Structured Query Language (SQL) database. The property database contains values for multiple attributes for each real estate property or records in the property database. Such property records comprise the rows of the database while the attributes comprise the columns. Attributes for the real estate property records include square footage, price, number of bedrooms, number of bathrooms, property size, real estate taxes, type of house, city, zip code, county, property type, for example single family home, townhouse, condominium, farm, industrial, etc. In the case of auction properties, such attributes may include the auction date and type of auction, for example, whether it is a judicial auction, sheriff's auction or an auction administered by a non-government entity. With respect to foreclosed or pre-foreclosure properties, such attribute criteria may include the date of the mortgage and the mortgage balance. The database also includes a geolocation identifier for the property such as a longitude and latitude coordinate. The database is periodically updated to add or remove real estate property records as real estate properties enter or leave the relevant market. Values for the attributes of the real estate properties in the database may be obtained from various sources including court records and property listing services.

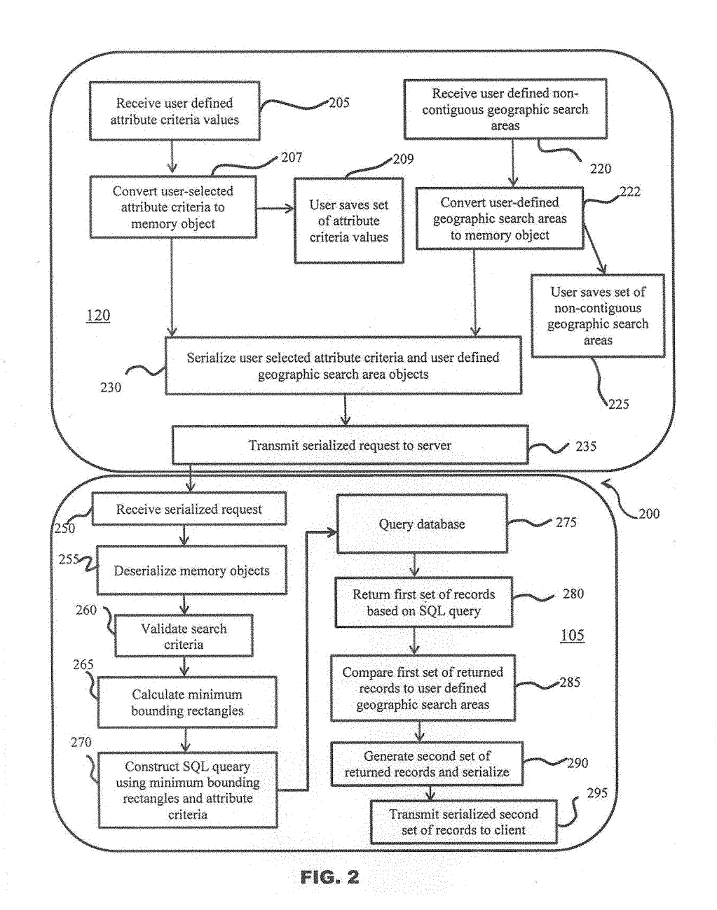

A flow diagram showing a method 200 for searching for a property based on user-defined geographic area and user-defined attributes is shown in FIG. 2. A user can build a query either by first defining a geographic area or by first selecting certain attributes to limit the search.

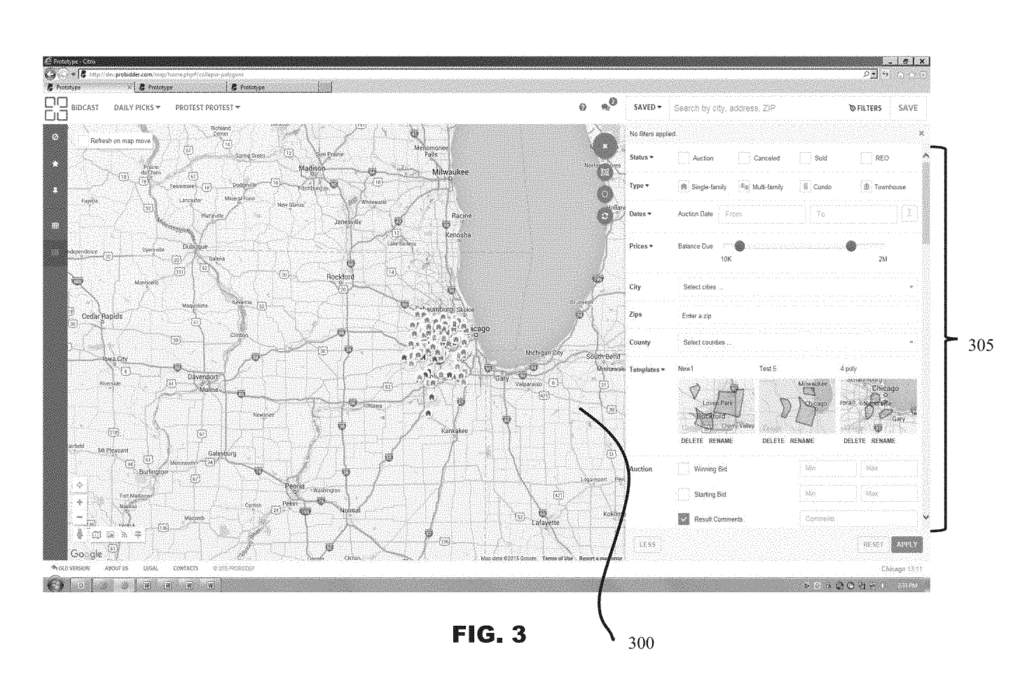

A user enters or selects values or a range of values from a prepopulated field, using the user interface of the client computer, to limit the search results for certain attributes of the desired real estate, step 205. FIG. 3 shows an exemplary attribute criteria selection screen 300 shown on a display, with a plurality of fields 305 for entering attribute values. For example, a user may select a first set of attribute criteria, which could include price (the attribute) between $100,000 and $150,000 (the value), number of bedrooms (the attribute) between 2 and 3 (the value), and property type (the attribute) “single family home” (the value). The user selected attribute criteria is preferably converted to a value object stored in portion of the browser memory so that such value object can be more easily manipulated programmatically, step 207.

The set of user-defined attribute criteria can be saved on memory and associated with the user, for example through association with a user login identification, step 209. The user can then create new sets of criteria by selecting different values for these attributes or other attributes and can save multiple attribute criteria sets.

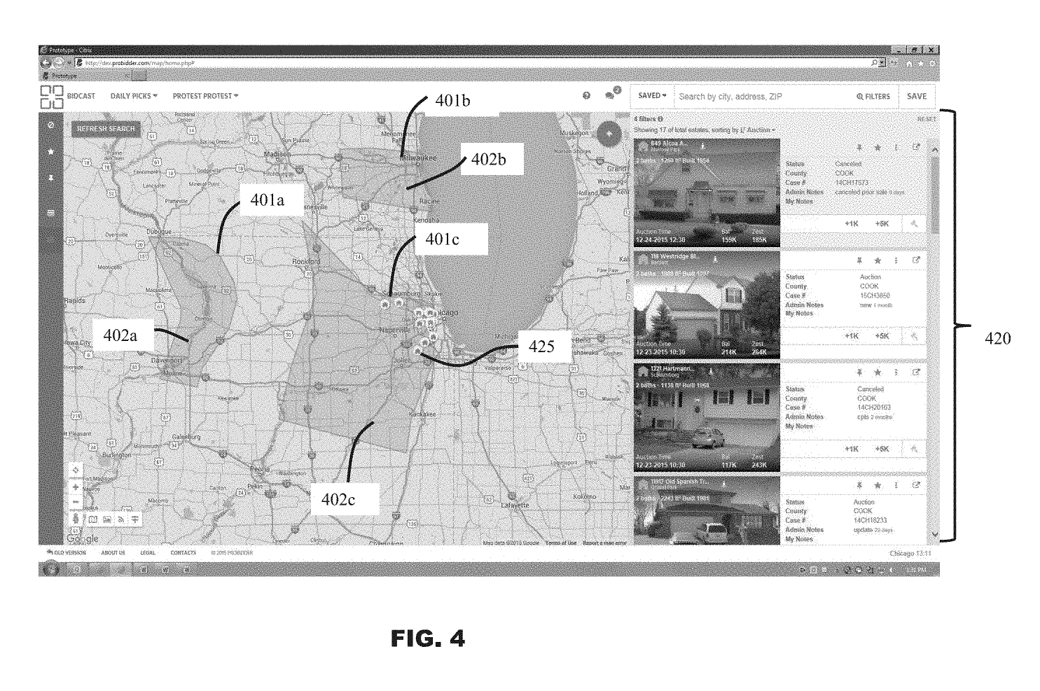

A user defines a geographic area by using the client computer input device, such as a mouse or touch screen, to draw a polygon on a map shown on the display of the client computer, step 220. In particular, the user draws a free-form shape on the map. An in-browser application best-fit matches lines to the free-form shape drawn by the user and displays a polygon, such as those shown in FIG. 4, 401a, 401b, 401c, approximating the free-form shape drawn by the user. The polygon defines a geographic area 402a, 402b, 402c bounded by lines and points forming corners approximating the free-form shape drawn by the user. The polygon drawn by the user defines the boundaries of the geographic search area. Multiple exemplary polygon search areas shown on a display are shown in FIG. 4. A user can draw a first polygon and subsequent non-contiguous polygons on a single map, as shown in FIG. 4. Such polygons may be overlaid on the map using a pre-existing map application such as Google Maps. The borders of the polygons define a geographic search area, which may be discontinuous, on the map.

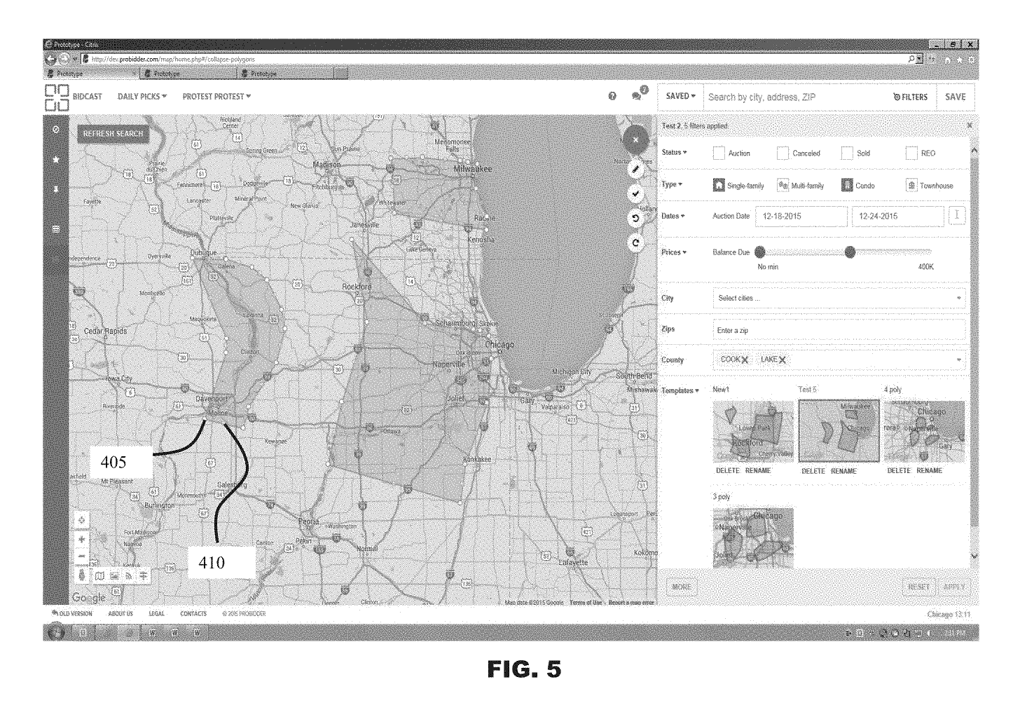

As shown in FIG. 5, the borders of the polygons 401a, 401b, 401c can be adjusted. Once a user selects an edit function, a series of circles appear on the polygon. The circles are placed on points of the polygon (shown as circle 405a) and the midpoint of each line of the polygon (shown as circle/point 410). The user can then adjust the polygon by clicking on one of the circle/points and dragging one of the points of the polygon 405 or the midpoint of one of the lines 410a of the polygon to a new position, thereby changing the area of the polygon.

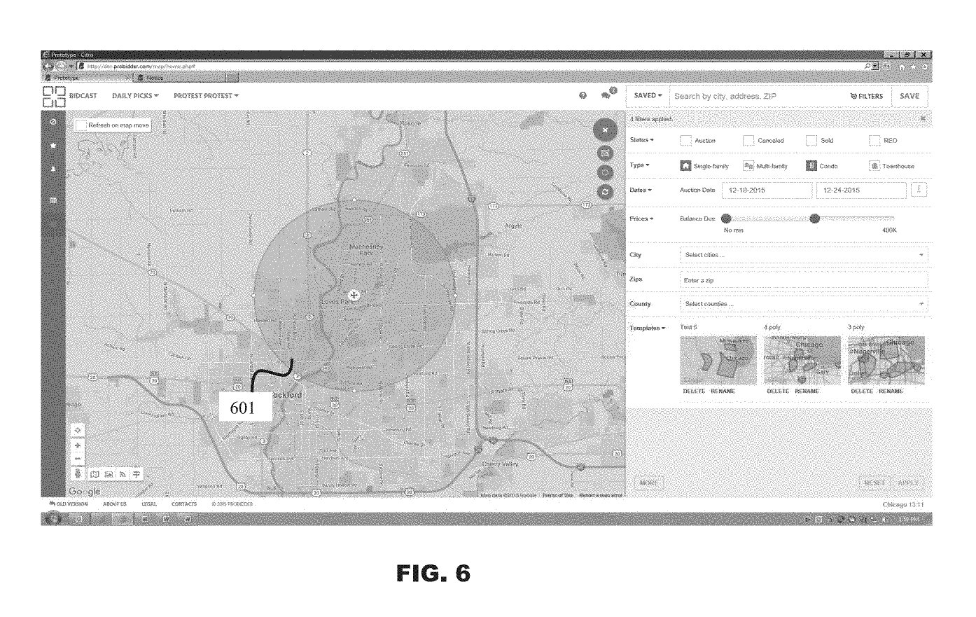

In addition to or instead of defining a geographic search area using polygons as described above, the system may also provide a tool for defining a geographic search area by drawing a circular geographic area 601 on the map, as shown in FIG. 6.

Returning to the method shown in FIG. 2, upon input, the user defined geographic search areas are preferably converted to a value object stored in portion of the browser memory so that such value object can be more easily manipulated programmatically, step 222. The user can save the user-defined geographic search area to the memory, step 225. The user can also save multiple different user-defined geographic search areas to the memory. The saved searches are associated with the user login ID or other user identifier.

The system enables the user to retrieve a saved geographic search area and combine that search area with selected attribute criteria. Thus, a user who has selected a set of attribute criteria can then select a first saved geographic search area to combine with the selected criteria, in effect applying the search area as a filter to the attribute criteria. The user can then deselect the first saved geographic search area and select a second saved geographic search area to combine with the attribute criteria. Similarly, the system enables the user to combine an attribute criteria set and multiple saved geographic search areas by selecting multiple saved geographic search areas from the display, i.e., the user could select both the first saved geographic search area and the second saved geographic search area for combination with the attribute criteria and apply both search area “filters.” In this way, a user who has identified different geographic areas of interest and saved those as geographic search areas can choose to view each of those geographic search areas individually or combine them. The system also provides tools to modify the retrieved saved attribute criteria and saved user-defined geographic area prior to initiating a search. Description of the performance of such searches is described in more detail below.

Once the user-defined attribute criteria and user-defined geographic area or areas are finalized, a request is transmitted to the processor. A transmission of a search request may be triggered either automatically in the case of criteria that has been defined as “dynamic,” in which case transmission of the combination of attributes and user-defined geographic area or areas occurs automatically when such dynamic criteria has been updated. Alternatively, transmission may occur non-dynamically or manually, for example, after a user clicks an “apply” button or otherwise takes an action to initiate transmission of the search request.

Upon initiation of transmission, the objects that represent the set of user selected attribute criteria and the user defined geographic search area are serialized to a Java Script Object Notification (“JSON”) character string by an in-browser application, step 230.

The in-browser application then transmits the serialized attribute search criteria and geographic search area to the processor 105, step 235. In a preferred embodiment, the serialized search criteria and geographic search area are transmitted to a backend API (Application Programing Interface) running on the server. In a specific embodiment, the transmitted request specifies its URL address and the body of the request using the XMLHttpRequest browser API.

After the processor 105 has received the request, step 250, it reverses the serialization of the request to restore it to a memory object format, step 255. The request is then validated by the processor, which compares the user selected search criteria to the expected input for the specific attribute and search criteria not matching the expected input type is disregarded, step 260. For example, the search criteria for a “number of bedrooms” attribute would be expected to be a numerical value or range of numerical values. Therefore, an alphabetical input for this attribute would be disregarded. Once the processor receives the user defined search area information, prior to applying such criteria to the database, the processor first creates a minimum bounding rectangle, step 265, which simplifies the comparison of the user defined area to the geographic locations of the properties in the database. In the case of a polygon search area, the processor defines the minimum bounding rectangle for a polygon by four coordinates, namely, the minimum latitude, maximum latitude, minimum longitude and maximum longitude of all points in polygon, thus creating a rectangle that encompasses all points in the polygon, potentially including other areas not inside of the polygon.

In the case of the circle search area or areas, the processor calculates the minimum bounding rectangle based on the centerpoint of the circle. The circle's radius is divided by the Earth's radius (approximated as 6,371 kilometers) to provide a difference from the circle's center latitude in radians (dLat). The difference from the circle's centerpoint longitude to the longitude sides of the minimum bounded rectangle (dLon) is determined as follows. The distance to the sphere surface at the latitude of interest is treated as the hypotenuse of a right triangle. The straight line width of a circular segment as wide as the circle's radius is forms a side S of the circular area. The Arcsine of the angle opposite S provides the difference from the circle's centerpoint to the longitude of the minimum boundary rectangle (i.e. dLon=arcsine(sin(radius/6371)/cosine(latitude))).

The maximum and minimum latitudes of the minimum boundary rectangle for the circular area are then calculated by adding dLat to, and subtracting dLat from, respectively, the latitude of the centerpoint of the circular area. Similarly, the maximum and minimum longitudes of the minimum boundary rectangle are calculated by adding/subtracting dLon to calculate the longitude of the centerpoint.

For search requests in which the user has defined a discontinuous geographic search area by using multiple unconnected polygons and/or circles, a minimum boundary rectangle will be determined for each such discontinuous area.

Having received the search request and having calculated the minimum boundary rectangles for the search areas, the processor 105 identifies relevant search results via a two-step process. As described in more detail below, first, the processor compares the real estate property records within the database to the values or range of values in the saved attribute criteria and the minimum boundary rectangles to identify a set of records (rows) of interest. Second, those records are compared to the user defined search areas to eliminate properties having a location that falls within the minimum boundary rectangle, but outside of the user defined search area.

In the first step, the processor constructs an SQL query using the minimum boundary rectangle information and the other user-defined attribute criteria to minimize the number of records or rows that match the search, step 270. Composite database indexing using the geographic inputs from the minimum boundary rectangle and user defined search criteria (e.g. [latitude, longitude, auction date] or [latitude, longitude, mortgage balance] or [latitude, longitude, owner name]) retrieves a results set, step 275, with less computational effort than otherwise would be required (in O(log n) steps instead of O(n) steps where n is the total number of rows in our database). This comparison generates a first results set, which is then further refined as described below.

Having retrieved the rows of interest that match both the user's attribute search criteria and minimum boundary rectangle conditions, step 280, the processor, using a database management system such as MariaDB/MySQL, compares all the geographic identifier for all such records/rows (k steps if number of matching rows is k) and checks if the latitudes and longitudes for the properties fall within the user defined polygons or circles using a pre-existing MySQL algorithm, step 285. This generates a second result set that is a subset of the first result set. Thus, the second result set of real estate property records that meet the attribute criteria and have locations that fall within the user-defined geographic areas is generated, step 290.

These results are then serialized as JSON data by the processor and transmitted to the client computer and displayed via to the user via the browser, step 295. The result set is displayed showing certain attributes of the real estate properties contained in the results set. As shown in FIG. 4, the result set display 420 includes an image of the property and certain property information for the result set properties. For example, as shown in FIG. 4, the address of the property, the amount remaining on a mortgage for a foreclosed property, an estimated value and auction date are displayed for each result for example. However, the displayed information could include a wide range of information relating to the property and stored in the database. The second results set is also displayed as pins on the map 425.

The user may also save the combined attribute criteria and user-defined geographic area as a saved search. The saved search is stored in memory and associated with the user. The saved search can be recalled by the user at a later point in time and “refreshed” by initiating a request for the processor to compare the values or range of values in the saved attribute criteria and the user-defined geographic areas of the saved search against the database to generate an up to date results set.

The user may also recall and modify a saved search at a later point in time. After recalling the saved search, which is retrieved from memory and transmitted to the user's client computer, the user can alter the attribute criteria and/or the saved user-defined geographic area. The attribute criteria may be altered by adding or removing criteria or modifying the values of the attribute criteria. The user-defined geographic search area can also be modified in a number of ways. First, a user can add or delete a non-contiguous polygonal area to the saved area. Second, a user can drag points of a pre-existing polygon to different locations on the map to alter the polygonal area. When the user is satisfied with the modifications, the user can then save those changes to the saved search or the user can save the modified saved search as a new saved search. In either case, the user can submit a search request for the modified saved search. Then, the values or range of values in the saved attribute criteria and the user-defined geographic areas of the modified saved search are compared by the processor against the database as described above to generate an up-to-date results set, which is displayed to the user as shown in FIG. 4.

In another aspect of the system, a user may use a geographic area to exclude certain geographic areas from a search. For example, a user could identify a first geographic area as a saved geographic search (or select a pre-saved geographic search area) and define a second exclusion geographic area that falls within the boundaries of the first geographic area. By combining the first geographic area with the exclusion area, the user can effectively create a search area with a “hole” in it. Like other geographic search areas, a minimum boundary rectangle is determined for an exclusion geographic area. Then, during the first step of comparison to the database, the processor checks the property records to determine whether they fall within the minimum boundary rectangle of the exclusion geographic area, and, if so, such properties are not included in the initial set of returned results. During the second step, the location of the properties in the initial record set are compared against the exclusion area. The combined geographic search area with the exclusion area can be saved and later recalled and applied as a filter against selected attribute criteria, just like other saved geographic search areas.

It should be emphasized that the above-described embodiments, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and protected by the following claims.

We claim:

1. A system for searching for real estate comprising:
a server communicatively connected to a database comprised of real estate records;
one or more client devices, wherein the one or more client devices receive a defined non-contiguous geographic search area and attribute criteria values for attributes of the sought real estate and the client devices transmit the defined non-contiguous geographic search area and attribute criteria values to the server; and
wherein the server calculates minimum bounding rectangles corresponding to the non-contiguous geographic search area, queries the database of real estate using the minimum bounding rectangles and attribute criteria values to generate a first set of returned records, compares the first set of returned records against the defined non-contiguous search area to generate a second set of returned records that is a subset of the first set of returned records, and transmits the second set of returned records to the client device.

2. The system of claim 1 wherein the one or more client devices convert the non-contiguous geographic search area to a first memory object and convert the attribute criteria values to a second memory object.

3. The system of claim 2 wherein the one or more client devices serialize the first memory object and the second memory object and wherein the server deserializer the first memory object and the second memory object.

4. The system of claim 1 wherein the server validates the attribute criteria values prior to the querying the database of real estate.

5. The system of claim 1 wherein the server calculates the minimum bounding rectangles for polygonal geographic areas based on minimum latitude, maximum latitude, minimum longitude and maximum longitude to define the four corners of the minimum bounding rectangle, and wherein, for circular search areas, the server calculates the minimum bounding rectangle based on the centerpoint and radius of the defined geographic search area.

6. The system of claim 1, wherein the one or more client devices include a display that displays the second set of returned records and the defined geographic search area on a map.

7. A method of searching for real estate comprising:
receiving, via a client, a defined non-contiguous geographic search area;
receiving, via a client, attribute criteria values for attributes of the sought real estate;
transmitting the defined non-contiguous geographic search area and attribute criteria values to a server;
calculating, at the server, minimum bounding rectangles corresponding to the non-contiguous geographic search area;
querying from the server a database of real estate using the minimum bounding rectangles and attribute criteria values to generate a first set of returned records;
comparing, at the server, the returned records against the defined non-contiguous search areas to generate a second set of returned records that is a subset of the first set of returned records;
transmitting from the server the second set of returned records to the client.

8. The method of claim 7 further comprising the steps of:
converting, at the client, the non-contiguous geographic search area to a first memory object; and
converting, at the client, the attribute criteria values to a second memory object.

9. The method of claim 8 further comprising the steps of:
serializing, at the client the first memory object and the second memory object; and
deserializing, at the server, the first memory object and second memory object.

10. The method of claim 7 further comprising the step of validating at the server the attribute criteria values prior to the step of querying a database of real estate.

11. The method of claim 7 wherein, for the calculation of minimum bounding rectangles for polygonal geographic areas, the minimum latitude, maximum latitude, minimum longitude and maximum longitude are used to define the four corners of the minimum bounding rectangle, and wherein, for circular search areas, the centerpoint and radius of the defined search area are used to calculate the minimum bounding rectangle.

12. The method of claim 7 further comprising the step of displaying the second set of returned records and defined geographic search area on a map shown on a display on the client.

13. The method of claim 12 wherein at least a first portion of the displayed geographic search area is defined by a polygon comprised of a plurality of lines connected by dots and where the lines and dots can be selected and moved by the user to adjust the shape of the polygon.

14. The method of claim 13 wherein at least a second portion of the displayed geographic search area is defined by a circle.

15. A method of searching for real estate comprising:
receiving from a client a serialized first memory object corresponding to a non-contiguous geographic search area;
receiving from a client a serialized second memory object corresponding to an attribute criteria values for attributes of the sought real estate;
deserializing, at the server, the first and second memory objects;
validating, at the server, the attribute criteria values;
calculating, at the server, minimum bounding rectangles corresponding to the non-contiguous geographic search area;
querying, from the server, a database of real estate using the minimum bounding rectangles and attribute criteria values to generate a first set of returned records;
comparing, at the server, the returned records against the defined non-contiguous search areas to generate a second set of returned records that is a subset of the first set of returned records; and
transmitting from the server the second set of returned records to the client.

16. The method of claim 15 wherein, for the calculation of minimum bounding rectangles for polygonal geographic areas, the minimum latitude, maximum latitude, minimum longitude and maximum longitude are used to define the four corners of the minimum bounding rectangle, and wherein, for circular search areas, the centerpoint and radius of the defined search area are used to calculate the minimum bounding rectangle.

17. A method of searching for real estate comprising:
receiving, via a client, a first defined non-contiguous geographic search area;
receiving, via a client, a second defined geographic search area;
combining the first defined non-contiguous geographic search area with the second defined geographic search area to create a third defined non-contiguous geographic search area;
receiving, via a client, attribute criteria values for attributes of the sought real estate;
transmitting, from the client, the third defined non-contiguous geographic search area and attribute criteria values to a server;
calculating, at the server, minimum bounding rectangles corresponding to the non-contiguous geographic search area;
querying, from the server, a database of real estate using the minimum bounding rectangles and attribute criteria values to generate a first set of returned records;
comparing, at the server, the returned records against the defined non-contiguous search areas to generate a second set of returned records that is a subset of the first set of returned records; and
transmitting the second set of returned records to the client.

18. The method of claim 17 further comprising the step of saving the first defined non-contiguous geographic search area to a customer account and recalling the first defined non-contiguous geographic search area prior to combining the first defined non-contiguous geographic search area with the second defined geographic search area.

19. The method of claim 17 further comprising the step of saving the attribute criteria values to a customer account.

20. The method of claim 19 further comprising the step of recalling saved attribute criteria values from a customer account prior to transmitting the attribute criteria values to the server.

21. A method of searching for real estate comprising:
receiving, via a client, user selected attribute criteria values for attributes of the sought real estate;
receiving, via a client, a selection of a pre-saved first geographic search area;
transmitting, from the client, the selected first geographic search area and attribute criteria values to a server;
calculating, at the server, minimum bounding rectangles corresponding to the first geographic search area;
querying, from the server, a database of real estate using the minimum bounding rectangles and attribute criteria values to generate a first set of returned records;
comparing, at the server, the returned records against the defined first geographic search area to generate a second set of returned records that is a subset of the first set of returned records; and
transmitting the second set of returned records to the client.

22. The method of claim 21 further comprising the steps of:
receiving via a client a deselection of the pre-saved first geographic search area;
receiving via a client a selection of a pre-saved second geographic search area; transmitting, from the client, the selected second geographic search area and attribute criteria values to a server;
calculating, at the server, minimum bounding rectangles corresponding to the second geographic search area; querying, from the server, a database of real estate using the minimum bounding rectangles and attribute criteria values to generate a third set of returned records;
comparing, at the server, the returned records against the defined second geographic search area to generate a fourth set of returned records that is a subset of the third set of returned records; and transmitting the fourth set of returned records to the client.

23. A method of searching for real estate comprising:
receiving, via a client, a first defined geographic search area;
receiving, via a client, a first defined exclusion geographic search area;
combining the first defined geographic search area with the first defined exclusion geographic search area to create a third defined geographic search area;
receiving, via a client, attribute criteria values for attributes of the sought real estate;
transmitting, from the client, the third geographic search area and attribute criteria values to a server;
calculating, at the server, minimum bounding rectangles corresponding to the geographic search area;
querying, from the server, a database of real estate using the minimum bounding rectangles and attribute criteria values to generate a first set of returned records;
comparing, at the server, the returned records against the third search areas to generate a second set of returned records that is a subset of the first set of returned records; and
transmitting the second set of returned records to the client.

24. The method of claim 23 wherein the a first defined geographic search area is a presaved geographic area selected by a user.

25. The method of claim 23 further comprising the step of saving the third geographic search area.
